(19) United States
(12) Patent Application Publication
(10) Pub. No.: US 2026/0279102 A1
(43) Pub. Date: Sep. 17, 2026

(54) SYSTEM APPARATUS AND METHOD OF GENERATING PHYSICAL ACTIVITY TRAINING PLAN

(71) Applicant: New Stream Ltd, Kfar Saba (IL)

(72) Inventors: Boris TYOMKIN, Kfar Sava (IL); Dragan MIRKOV, Belgrade (RS); Dmitry KANEVSKI, Kfar Yona (IL)

(21) Appl. No.: 19/076,093

(22) Filed: Mar. 11, 2025

(51) Int. Cl. G06V 40/20; G06Q 10/0639; G06V 10/77

(52) U.S. Cl. CPC G06V 40/23; G06Q 10/06393; G06V 10/77

(57) ABSTRACT

A system, device, and method for generating a training plan based on the biomechanical qualities of a trainee. The method includes activating an image sensor to record a video of a predefined movement by a sports trainee in a specified plane using a camera from the user device to produce a video clip. In the video clip, two or more keypoints are marked on two or more predetermined points on the body of the sports trainee. The coordinates of these keypoints are extracted using a first artificial intelligence (AI) model, and two or more points of interest (POI) are detected from the coordinates. The detected POIs are validated against the predetermined points at the beginning part of the validation process, and two or more key performance indicators (KPIs) are calculated based on this validation. Metrics of the KPIs are computed using one or more rules provided by a metrics rule engine. A grading process is then applied to the KPIs based on rules set forth by a grading rule engine, resulting in a biomechanical report of the sports trainee. Additionally, a biomechanical model of the sports trainee is generated alongside a practice plan that includes one or more exercises tailored by a second AI model. These exercises are designed to fit the biomechanical model of the sports trainee to mitigate the risk of injuries.

### TECHNICAL FIELD

Some embodiments described herein are generally related to generating a physical activity training program for a trainee.

### BACKGROUND

Physical activity plays an important role in daily life for people of all populations and ages. Professional sportspeople and athletes, such as basketball, football, soccer, and the like, are exposed to injuries during training and/or games because the training plan does not match their biomechanical qualities.

A plurality of systems processing methods are used to train people for physical activity. However, those systems may include a predetermined set of workouts and movements, which may cause injuries to some sportspeople or athletes because their biomechanical qualities do not match the training plan.

### BRIEF DESCRIPTION OF THE DRAWING

FIG. 1 illustrates block diagrams of a system for generating an assessment report and a training plan based on the biomechanic qualities of a trainee, according to some demonstrative embodiments.

FIG. 2 illustrates a block diagram detailing a process flow for generating an assessment report and a training plan based on a trainee's biomechanical qualities in accordance with some demonstrative embodiments.

FIG. 3 illustrates a setup for capturing a three-dimensional (3D) motion video of a sports trainee for a validation phase, according to some demonstrative embodiments.

FIG. 4 illustrates an example of mapping keypoints on a body of a sports trainee, according to some demonstrative embodiments.

FIG. 5 illustrates a flow chart of a method for generating an assessment report and a training plan based on the biomechanic qualities of a trainee, according to some demonstrative embodiments.

FIG. 6 illustrates a product of manufacture, according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to, and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “logic” may refer, for example, to computing logic embedded in the circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

The term “module,” as used hereinbelow is an object file that contains code to extend the running kernel environment.

As used herein, the term “Artificial intelligence (AI)” is intelligence demonstrated by machines, unlike the natural intelligence displayed by humans and animals, which involves consciousness and emotionality. The term “artificial intelligence” is used to describe machines (or computers) that mimic “cognitive” functions that humans associate with the human mind, such as, for example, “learning” and “problem-solving.”

The term “machine learning (ML)” as used hereinbelow is a study of computer algorithms configured to improve automatically based on a received. ML is a subset of artificial intelligence. Machine learning algorithms build a mathematical model based on sample data, known as “training data,” to make predictions or decisions without being explicitly programmed to do so.

As used herein, the term “deep learning,” as used hereinbelow, is a class of machine learning algorithms that uses multiple layers to extract higher-level features from the raw input progressively. For example, in image processing, lower layers may identify edges, while higher layers may identify the concepts relevant to a human, such as, for example, digits or letters and/or faces.

The term “Artificial neural networks (ANNs), and/or neural networks (NNs), are computing systems vaguely inspired by the biological neural networks that constitute animal brains.

For example, an ANN is based on a collection of connected units or nodes called artificial neurons, which loosely model the neurons in a biological brain. An artificial neuron that receives a signal may process it and may signal neurons connected to it. For example, the “signal” at a connection is a real number, and the output of each neuron is computed by some non-linear functions of the sum of its inputs. The connections are called edges. Neurons and edges may have a weight that adjusts as learning proceeds. The weight increases or decreases the strength of the signal at a connection. Neurons may have a threshold such that a signal is sent only if the aggregate signal crosses that threshold. The neurons may be aggregated into layers. Different layers may perform different transformations on their inputs.

In some demonstrative embodiments, ways to use non-wearable sensing technologies (like video) to monitor and analyze a subject and provide feedback to a user. For example, the feedback may be based on artificial intelligence (AI) trained on expert knowledge, analytical models, and success with the targets of the interacting objects, e.g., scoring a goal.

The term “Computer vision,” as used hereinbelow, is a field within artificial intelligence (AI) that focuses on enabling machines to interpret and understand visual information from the world, similar to how humans do. It involves the development of algorithms and models that can analyze images and videos to extract meaningful information. For example, image recognition, object detection, image segmentation, facial recognition, Optical Character Recognition (OCR) and the like.

The term “keypoint(s),” as used hereinbelow, refers to anatomical landmarks, primarily points on joints. These points may be detected automatically. Based on calibration, the object identifies the 2D spatial coordinates of the points and utilizes them for further automation, such as, for example, by using a calculation algorithm.

In some demonstrative embodiments, a system for generating a physical activity scenery training plan for a trainee based on the biomechanic qualities of a trainee is presented. For example, the system may include a user device comprising processing circuitry and one or more sensors, for example, a cellphone.

The term “Gold standard measurement,” as used hereinbelow, refers to the highest standard or benchmark measurement against which other measurements or tests are compared. In various fields such as medicine, science, and engineering, the gold standard is considered the most accurate and reliable method available. It serves as a reference point to ensure the quality and accuracy of other methods or measurements. The term can also be used metaphorically to describe any standard or benchmark that is considered the best or most reliable in a particular context.

In some demonstrative embodiments, the processing circuitry may be configured to activate an image sensor, e.g., a camera on the cellphone, to record a video of a predefined movement and/or movements of the trainee in a predetermined plane to provide a video clip. For example, the video clip may be stored on the memory of the user device, e.g., cellphone, and/or on the cloud.

In some demonstrative embodiments, the processing circuitry may operate an application for generating the training plan based on the video clip. For example, the application may mark two or more keypoints on two or more predetermined points on the body of the sports trainee on frames of the video clip, extract the coordinates of the two or more keypoints using an artificial intelligence (AI) model, and detect two or more points of interest (POI) from the coordinates. For example, the POIs may be defined as: points exceeding a predefined threshold, points of sign change, and local minima or maxima, which indicate peaks or troughs in motion. The POIs may be used to define the beginning and end of predetermined phases of interest for an analysis of the motion of the sports trainee in the video clip. Furthermore, the processing circuitry may identify the POIs on a distance-time and a velocity-time trace derived from the z and x components of two or more keypoints in a 2D space.

In some demonstrative embodiments, the extraction of the coordinates may include extracting from frames of the recorded video clip one or more components that represent a time (t), the vertical motion (z), and the horizontal motion (x) of the sports trainee by using computer vision with machine learning methods. For example, machine learning may be configured to train a dataset based on one or more trainee biomechanical data and one or more sports accessories, e.g., cones and the like.

Furthermore, the processing circuitry may validate the detected two or more POIs against the two or more predetermined points and may calculate two or more key performance indicators (KPIs) based on the validation. For example, the validation may be proved by academic research, which may be a controlled study in the lab by comparison with gold standard measurement.

For example, the validation may include capturing two or more keypoints by synchronously recording the sports trainee's motion using a two-dimensional (2D) video camera on the user device. Then, the two or more keypoints captured by the 3D motion capture system and the 2D video camera may be compared to recognize the sports trainee's body position.

In some demonstrative embodiments, the grading process may be done by a KPI grader operably coupled to a grading rule engine. The processing circuitry may calculate metrics for the KPIs based on one or more rules provided by a metrics rule engine, apply a grading process to two or more KPIs based on one or more rules provided by the grading rule engine, and provide a biomechanical report of the sports trainee.

For example, the grading process may include converted absolute values of each KPI into relative values based on the KPI's indicator, provide mean and standard deviation values to an age group and a gender of the trainee, wherein the mean and standard deviation values were primarily calculated using data collected through standardized measurement procedures.

For example, the trainee age for a particular testing session may be calculated based on the date of birth of the trainee and the testing date of the trainee, where the age of the trainee is categorized into an age group. For example, the age group may include: an under-nine years old (U9) age group, an under-eleven years old (U11) age group, an under-thirteen years old (U13) age group, an under-fifteen years old (U15) age group, an under-seventeen years old (U17) age group, an under-nineteen years old (U19) age group, and a seniors age group.

In some demonstrative embodiments, the grading process further includes filtering a grade database by the selected age group and gender to select the mean and standard deviation for the given KPI. For example, the values of the selected age group and gender may be subsequently used to convert the absolute KPI into a grade having a percentile value.

For example, the grade database may include data collected from an international sample of athletes from various sports, spanning different age groups ranging from nine to forty years old, including both males and females over a predefined period.

In some demonstrative embodiments, the processing circuitry may generate a biomechanical model of the sports trainee along with a practice plan that includes one or more exercises, potentially created by another AI engine. These exercises may be tailored to the biomechanical model of the sports trainee and designed to minimize the risk of injury to the sports trainee.

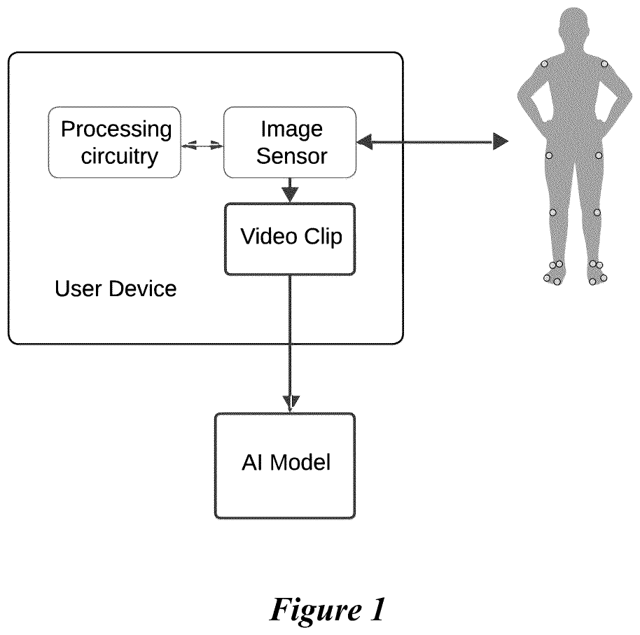

Turning first to FIG. 1, which is an illustration of block diagrams of a system 100 for generating an assessment report and a training plan based on the biomechanic qualities of a trainee, according to some demonstrative embodiments.

In some demonstrative embodiments, system 100 may include a user device 110, e.g., a cellphone, a tablet, a laptop, an all-in-one computer, and the like. The user device 110 may include processing circuitry 120, for example, a motherboard that includes a processor, one or more memories, and the like, and one or more sensors 130, e.g., an image sensor, a camera, a video camera, and the like.

In some demonstrative embodiments, the processing circuitry 120 may be configured to activate one or more sensors 130, e.g., the image sensor 130, to record a video of a predefined movement of a sports trainee 150 within a predetermined plane 155 using a camera of the user device 110 to provide a video clip 140.

In some demonstrative embodiments, on the video clip 140, the processing circuitry 120 may mark two or more keypoints 160 on two or more predetermined points on a body of the sports trainee 150, extract coordinates of the two or more keypoints by using an artificial intelligence (AI) model 125 and may detect two or more points of interest (POI) from the coordinates.

Furthermore, the processor circuitry 120 may validate the detected two or more POI against the two or more predetermined points and may calculate two or more key performance indicators (KPIs) based on the validation. For example, the comparison may be performed only once at the beginning as part of our validation process. For each test, measurements may be conducted in parallel using two systems: one as the gold standard and the other as described at least in FIG. 1. The KPIs are calculated for both systems using identical methodologies. When the KPIs from both systems are highly correlated, they are considered accurate enough for practical use. The processor circuitry 120 may calculate metrics of the KPIs based on one or more rules provided by a metrics rule engine, may apply a grading process to the two or more KPIs based on one or more rules provided by a grading rule engine and may provide a biomechanical report of the sports trainee.

The processing circuitry 120 may generate a biomechanical model 180 and/or a practice plan 170 for the sports trainee 150, which includes one or more exercises generated by a second AI model 127. The one or more exercises may be adapted to the biomechanical model 180 of the sports trainee 150.

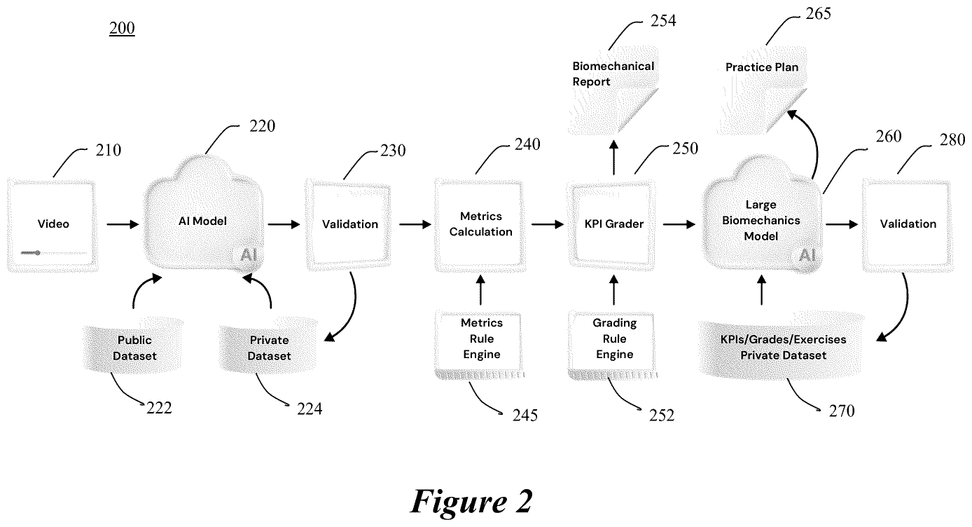

Turning to FIG. 2 illustrates a block diagram detailing a process flow for generating an assessment report and a training plan based on a trainee's biomechanical qualities in accordance with some demonstrative embodiments.

In some demonstrative embodiments, application 200 may analyze a video clip 210 of a sports trainee executing one or more predetermined exercises using an AI model 220. The AI model 220 may use Artificial neural networks (ANN) and/or machine learning to learn the biomechanical qualities of the sports trainee using a plurality of datasets taken from a public dataset and/or database 222 and a private dataset and/or database 224.

In some demonstrative embodiments, the AI model 220 may mark two or more keypoints on two or more predetermined points on the body of the sports trainee on frames of the video clip 210, may extract the coordinates of the two or more keypoints, and may detect two or more points of interest (POI) from the coordinates. For example, the two or more keypoints on two or more predetermined points on the body of the sports trainee may include an anatomical landscape of the trainee.

For example, POIs may be defined as points exceeding a predefined threshold, points of sign change, and local minima or maxima, which indicate peaks or troughs in motion. The POIs may be used to define the beginning and end of predetermined phases of interest for an analysis of the motion of the sports trainee in video clip 210. Furthermore, the AI model 220 may identify the POIs on a distance-time and velocity-time trace derived from the z and x components of two or more key points in a 2D space.

For example, using computer vision and/or machine learning methods, one or more components representing the time (t), vertical motion (z), and horizontal motion (x) of the sports trainee may be extracted from the recorded video clip 210.

In some demonstrative embodiments, during validation stage 230 of the process, capturing two or more keypoints involves synchronously recording the motion of the sports trainee using a two-dimensional (2D) video camera, such as, for example, image sensor 130 (FIG. 1) of the user device, e.g., user device 110 (FIG. 1). The two or more keypoints captured by a 3D motion capture system (not shown) may then be compared to those from the 2D video camera to recognize the body position of the sports trainee and store this position in a private dataset and/or database 224.

For example, the comparison may include at least one of comparing one or more distance-time and velocity-time traces, ankle traces, knee traces, and hip motion traces over time, derived from the vertical motion (z) and horizontal motion (x) components of selected body keypoints in 2D space, as captured by the 2D video camera, e.g., image sensor 130 (FIG. 1).

For example, the trainee age for a particular testing session may be calculated based on the date of birth of the trainee and the testing date of the trainee, where the age of the trainee is categorized into an age group.

For example, the age groups may include children under nine years old (U9), children under eleven years old (U11), children under thirteen years old (U13), children under fifteen years old (U15), children under seventeen years old (U17), children under nineteen years old (U19), and seniors. However, it should be understood that this is an example only, and other and/or different age groups may be used.

In some demonstrative embodiments, after validation 230, a metrics calculation 240 may have been done. The metrics calculation stage 240 may include calculating metrics of the KPIs based on one or more rules provided by a metrics rule engine 245.

In some demonstrative embodiments, having the metrics for the KPI, a KPI grader 250 operably coupled to a grading rule engine 252 may do the grading process and generate a biomechanical report 254. The grading process may include converting absolute values of each KPI into relative values based on the KPI's indicator providing mean and standard deviation values to an age group and a gender of the trainee, wherein the mean and standard deviation values were primarily calculated using data collected through standardized measurement procedures.

For example, Z-Score and Percentile Calculation for HCMJ (cm) may calculate as described below according to the data of Table 1 below.

| Gender | Age Group | Mean (cm) | SD (cm) |
|---|---|---|---|
| F | U09 | 19.7 | 3.9 |
| F | U11 | 23.8 | 4.8 |
| F | U13 | 24.8 | 5.0 |
| F | U15 | 26.8 | 4.7 |
| F | U17 | 28.7 | 5.0 |
| F | U19 | 31.5 | 4.7 |
| F | U21 | 31.6 | 4.7 |
| F | Senior | 31.6 | 4.7 |
| M | U09 | 20.0 | 4.0 |
| M | U11 | 21.9 | 4.4 |
| M | U13 | 24.4 | 4.9 |
| M | U15 | 29.4 | 5.1 |
| M | U17 | 35.6 | 6.2 |
| M | U19 | 38.6 | 5.8 |
| M | U21 | 40.7 | 6.1 |
| M | Senior | 40.7 | 6.1 |

For example, statistical data for a male U19 athlete's maximum jump height (HCMJ) may be used. The Z-score may be calculated by applying the equation Z=(X−μ)/σ (Eq 1), where X is the athlete's jump height, μ is the mean, and σ is the standard deviation. The resulting Z-score determines the percentile rank from the standard normal distribution. For example, Z=(41.2−38.6)/5.8 Z=0.45 (rounded to two decimal places). Using statistical tables or functions, the cumulative probability corresponding to Z=0.45 is approximately 0.673. This means the subject performed better than 67.3% of the male U19 population. According to this example, the ranking is in the 67.3rd percentile, which means that the sportsman is performing above average.

In some demonstrative embodiments, the grading process may further include filtering a grade database by a selected age group and gender to select the mean and standard deviation for the given KPI. Subsequently, the values of the selected age group and gender may be used to convert the absolute KPI into a grade with a percentile value.

In some demonstrative embodiments, an AI model 260 may generate a biomechanical model and a practice plan 265 for the sports trainee. For example, the practice plan 265 may include one or more exercises adapted to the sports trainee's biomechanical model.

For example, the practice plan logic integrates athlete-specific data (age, gender, sport, position, injuries) and KPIs (e.g., jump height, acceleration, change of direction) to assign graded performance levels (A+ to E). AI model 260 may map deficiencies to corrective exercises, dynamically adjusting practice plans based on training cycles, practice frequency, and physical conditioning needs.

In some demonstrative embodiments, the biomechanical model and/or practice plan generated by AI model 260 may be validated by a validation model 280. The validated practice plan and/or the biomechanical model of a specific sports trainee may be stored in a KPIs/Grades/Exercises dataset and/or database 270.

For example, the KPIs/Grades/Exercises dataset and/or database 270 may include data collected from an international sample of athletes from various sports, spanning different age groups ranging from nine to forty years old, including both males and females over a predefined period.

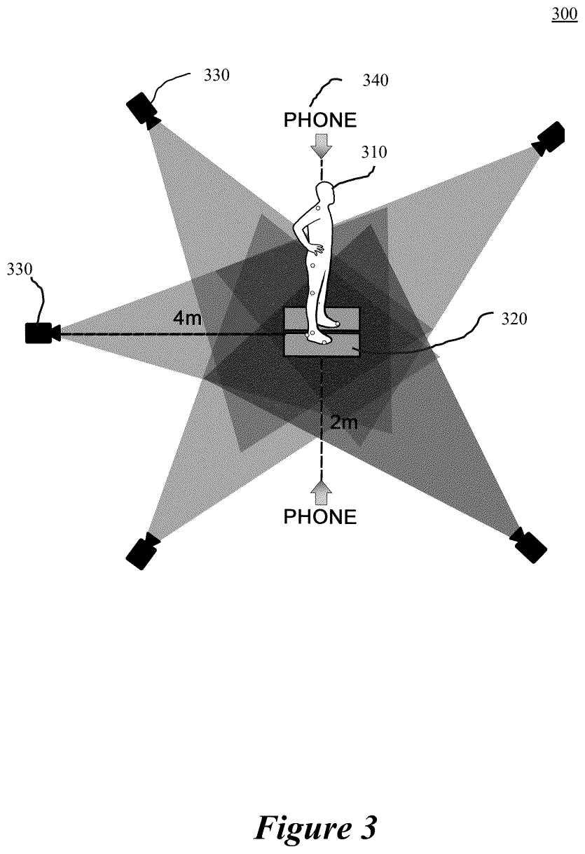

Reference is now made to FIG. 3, which is a schematic illustration of an example of a setup for capturing a three-dimensional (3D) motion video of a sports trainee for a validation phase 300, according to some demonstrative embodiments.

In some demonstrative embodiments, the setup 300 may include a plurality of video cameras 330 located at a predetermined distance, for example, 4 meters (m), around a sports trainee 300 standing on the plan 320. For example, a phone 310, located 2 m from the trainee, may capture a video of the sports trainee in a 2D space to mark the KPI of the body of the sports trainee 310. The KPIs of the sports trainee may be validated with the KPIs captured by the plurality of the video cameras 330.

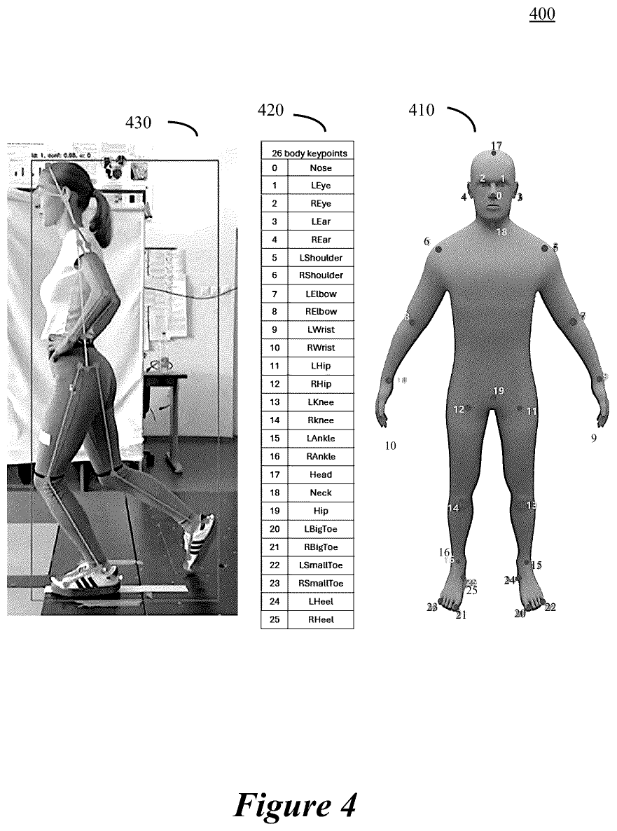

Reference is now made to FIG. 4, which is a schematic illustration of an example of mapping keypoints on a body of a sports trainee, according to some demonstrative embodiments. For example, an AI model may train to provide keypoints to a sports trainee by analyzing a video frame 430 of the sports trainee based on a human body 410 having, for example, 26 keypoints. The keypoints are described at table 420, and Table 2 below.

TABLE 1
26 keypoints of a human body
26 Body Keypoints

| | |
|---|---|
| 0 | Nose |
| 1 | Left Eye |
| 2 | Right Eye |
| 3 | Right Ear |
| 4 | Left Ear |
| 5 | Left Shoulder |
| 6 | Right Shoulder |
| 7 | Left Elbow |
| 8 | Right Elbow |
| 9 | Left Wrist |
| 10 | Right Wrist |
| 11 | Left Hip |
| 12 | Right Hip |
| 13 | Left Knee |
| 14 | Right Knee |
| 15 | Left Ankil |
| 16 | Right Ankil |
| 17 | Head |
| 18 | Neck |
| 19 | Hip |
| 20 | Left Big Toe |
| 21 | Right Big Toe |
| 22 | Left Small Toe |
| 23 | Right Small Toe |
| 24 | Left Heel |
| 25 | Right Heel |

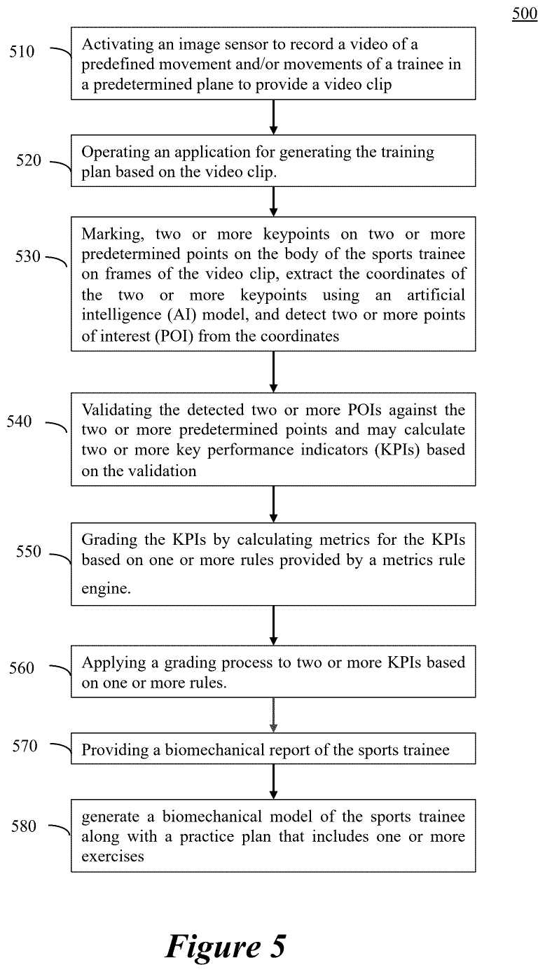

Reference is now made to FIG. 5, which is a schematic illustration of a flow chart of a method 500 for generating an assessment report and a training plan based on the biomechanic qualities of a trainee, according to some demonstrative embodiments.

In some demonstrative embodiments, the method 500 may start with activating an image sensor, e.g., a camera on the cellphone, to record a video of a predefined movement and/or movements of the trainee in a predetermined plane to provide a video clip (text box 510). For example, the video clip may be stored on the memory of the user device, e.g., cellphone, and/or on the cloud.

The method may proceed with operating an application for generating the training plan based on the video clip (text box 520). For example, the application may mark two or more keypoints on two or more predetermined points on the body of the sports trainee on frames of the video clip (keypoints 410, 420 in FIG. 4), extract the coordinates of the two or more keypoints using an artificial intelligence (AI) model, and detect two or more points of interest (POI) from the coordinates (text box 530)

In some demonstrative embodiments, the extraction of the coordinates may include extracting from frames of the recorded video clip one or more components that represent a time (t), the vertical motion (z), and the horizontal motion (x) of the sports trainee by using computer vision with machine learning methods. For example, machine learning may be configured to train a dataset based on one or more trainee biomechanical data and one or more sports accessories, e.g., cones and the like.

Furthermore, the processing circuitry may validate the detected two or more POIs against the two or more predetermined points and may calculate two or more key performance indicators (KPIs) based on the validation. For example, the validation may be proved by academic research, which may be a controlled study in the lab by comparison with gold standard measurement.

For example, the validation may include capturing two or more keypoints by synchronously recording the sports trainee's motion using a two-dimensional (2D) video camera on the user device. Then, the two or more keypoints captured by the 3D motion capture system and the 2D video camera may be compared to recognize the sports trainee's body position.

In some demonstrative embodiments, the grading process may be done by a KPI grader operably coupled to a grading rule engine. The processing circuitry may calculate metrics for the KPIs based on one or more rules provided by a metrics rule engine, apply a grading process to two or more KPIs based on one or more rules provided by the grading rule engine, and provide a biomechanical report of the sports trainee.

For example, the grading process may include converted absolute values of each KPI into relative values based on the KPI's indicator, provide mean and standard deviation values to an age group and a gender of the trainee, wherein the mean and standard deviation values were primarily calculated using data collected through standardized measurement procedures.

For example, the trainee age for a particular testing session may be calculated based on the date of birth of the trainee and the testing date of the trainee, where the age of the trainee is categorized into an age group. For example, the age group may include: an under-nine years old (U9) age group, an under-eleven years old (U11) age group, an under-thirteen years old (U13) age group, an under-fifteen years old (U15) age group, an under-seventeen years old (U17) age group, an under-nineteen years old (U19) age group, and a seniors age group.

In some demonstrative embodiments, the grading process further includes filtering a grade database by the selected age group and gender to select the mean and standard deviation for the given KPI. For example, the values of the selected age group and gender may be subsequently used to convert the absolute KPI into a grade having a percentile value.

For example, the grade database may include data collected from an international sample of athletes from various sports, spanning different age groups ranging from nine to forty years old, including both males and females over a predefined period.

In some demonstrative embodiments, the processing circuitry may generate a biomechanical model of the sports trainee along with a practice plan that includes one or more exercises, potentially created by another AI engine. These exercises may be tailored to the biomechanical model of the sports trainee and designed to minimize the risk of injury to the sports trainee.

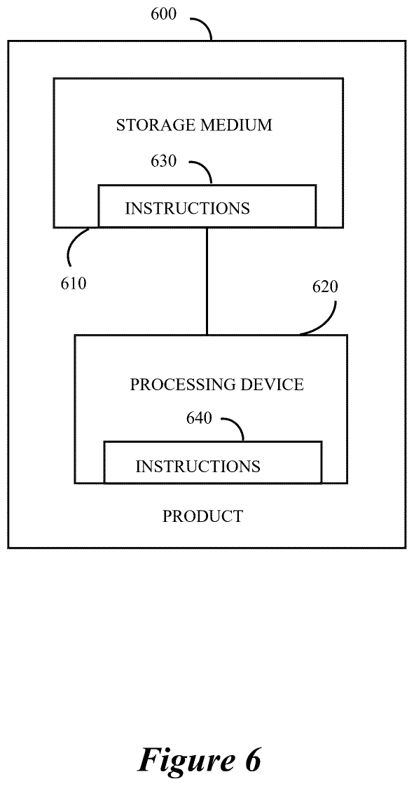

Reference is now made to FIG. 6, which is a schematic illustration of a product of manufacture 600, according to some demonstrative embodiments. Product 600 may include one or more tangible computer-readable non-transitory storage media 610, which may include computer-executable instructions 630, implemented by processing device 620, operable to, when executed by at least one computer processor, enable at least one processing device 120 (FIG. 1) to implement one or more program instructions for monitoring, analyzing and providing feedback to a trainee base on the performance as described above with reference to FIGS. 1 and 2 The phrase “non-transitory machine-readable medium” is directed to include all computer-readable media, with the sole exception being a transitory propagating signal.

In some demonstrative embodiments, product 600 and/or machine-readable storage medium 610 may include one or more types of computer-readable storage media capable of storing data, including volatile memory, non-volatile memory, removable or non-removable memory, erasable or non-erasable memory, writeable or re-writeable memory, and the like. For example, machine-readable storage medium 610 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusen drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative embodiments, processing device 620 may include logic. The logic may include instructions, data, and/or code, which, if executed by a machine, may cause the machine to perform a method, process, and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 620 may include or may be implemented as software, firmware, a software module, an application, a program, a subroutine, instructions, an instruction set, computing code, words, values, symbols, and the like. Instructions 640 may include any suitable types of code, such as source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled and/or interpreted programming languages, such as C, C++, C#, Java, Python, BASIC, Matlab, assembly language, machine code, and the like.

It is to be understood that the system and/or the method for generating a training plan based on the biomechanic qualities of a trainee is described hereinabove by way of example only. Other embodiments may be implemented based on the detailed description and the claims that followed.

It is to be understood that like numerals in the drawings represent like elements through the several figures and that not all components and/or steps described and illustrated with reference to the figures are required for all embodiments or arrangements.

It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein.

It should be appreciated that according to at least one embodiment, one or more computer programs, modules, and/or applications that, when executed, perform methods of the present invention need not reside on a single computer or processor but can be distributed in a modular fashion amongst a number of different computers or processors to implement various aspects of the systems and methods disclosed herein.

Thus, illustrative embodiments and arrangements of the present systems and methods provide a computer-implemented method, computer system, and computer program product for processing code(s). The flowchart and block diagrams in the Figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

It should also be noted that, in some alternative implementations, the functions noted in the block can occur out of order noted in the figures. For example, two blocks shown in succession may be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by particular purpose hardware-based systems that perform the specified functions or acts or combinations of specialized purpose hardware and computer instructions.

The terminology used herein is to describe particular embodiments only and is not intended to be limiting the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein are for the purpose of description and should not be regarded as limiting. The use of “including,” “comprising,” or “having,” “containing,” “involving,” and variations thereof herein is meant to encompass the items listed thereafter and equivalents thereof as well as additional items.

### EXAMPLES

The following examples pertain to further embodiments.

Example 1 includes a system for generating a training plan based on the biomechanic qualities of a trainee, comprising a user device comprising processing circuitry and one or more sensors, wherein the processing circuitry is configured to: activate an image sensor to record a video of a predefined movement of a sports trainee in a predetermined plane using a camera of the user device to provide a video clip; on the video clip, mark two or more keypoints on two or more predetermined points on a body of the sports trainee, extract coordinates of the two or more keypoints by using a first artificial intelligence (AI) model and detect two or more points of interest (POI) from the coordinates; validate the detected two or more POI against the two or more predetermined points and calculate two or more key performance indicators (KPIs) based on the validation; calculate metrics of the KPIs based on one or more rules provided by a metrics rule engine; apply a grading process to the two or more KPIs based on one or more rules provided by a grading rule engine and provide a biomechanical report of the sports trainee; generate a biomechanical model of the sports trainee and a practice plan for the sports trainee having one or more exercises by a second AI model, wherein the one or more exercises are adapted to the biomechanical model of the sports trainee.

Example 2 includes the subject matter of Example 1, and optionally, wherein the one or more exercises are designed to reduce the risk of injury of the sports trainee.

Example 3 includes the subject matter of Example 1, and optionally, wherein the validation comprises capturing the two or more keypoints by synchronously recording a motion of the sports trainee by a two-dimensional (2D) video camera of the user device and comparing the two or more keypoints captured by a three-dimensional (3D) motion capture system and the 2D video camera to recognize the body position of the sports trainee.

Example 4 includes the subject matter of Example 3, and optionally, wherein the comparison comprises at least one of: one or more distance-time and velocity-time traces, ankle traces, knee traces, and hip motion traces over time, derived from a vertical motion (z) and a horizontal motion (x) components of selected body keypoints in the 2D space, as captured by the 2D video camera.

Example 5 includes the subject matter of Example 1, and optionally, wherein the two or more keypoints on two or more predetermined points on a body of the sports trainee comprise an anatomical landscape of the trainee.

Example 6 includes the subject matter of Example 1, and optionally, wherein the extraction of the coordinates comprises: extract from the recorded video clip one or more components which represent a time (t), the vertical motion (z), and the horizontal motion (x) of the sports trainee by using computer vision with machine learning methods.

Example 7 includes the subject matter of Example 6, and optionally, wherein the detection of POI comprises: identify the POIs on a distance-time and a velocity-time trace derived from the z and x components of two or more keypoints in a 2D space, wherein the POIs are defined as: points exceeding a predefined threshold, points of sign change, and local minima or maxima, which indicate peaks or troughs in motion.

Example 8 includes the subject matter of Example 7, and optionally, wherein the POIs are used to define the beginning and end of predetermined phases of interest for an analysis of the motion of the sports trainee in the video clip.

Example 9 includes the subject matter of Example 1, and optionally, wherein the machine learning is configured to train a dataset based on one or more trainee biomechanical data and one or more sports accessories.

Example 10 includes the subject matter of Example 1, and optionally, wherein one or more sports accessories comprise one or more cones.

Example 11 includes the subject matter of Example 1, and optionally, wherein the grading process is done by a KPI grader operably coupled to a grading rule engine and comprises: convert absolute values of each KPI into relative values based on the KPI's indicator; provide mean and standard deviation values to an age group and a gender of the trainee, wherein the mean and standard deviation values were primarily calculated using data collected through standardized measurement procedures.

Example 12 includes the subject matter of Example 10, and optionally, wherein the trainee age for a particular testing session is calculated based on the date of birth of the trainee and the testing date of the trainee, where the age of the trainee is categorized into an age group.

Example 13 includes the subject matter of Example 11, and optionally, comprises at least one age group comprising children under nine years old (U9), children under eleven years old (U11), children under thirteen years old (U13), children under fifteen years old (U15), children under seventeen years old (U17), children under nineteen years old (U19), and seniors.

Example 14 includes the subject matter of Example 10, and optionally, wherein the grading further comprises: filtering a grade database by a selected age group and gender to select the mean and standard deviation for the given KPI, wherein values of the selected age group and the gender are subsequently used to convert the absolute KPI into a grade having a percentile value.

Example 15 includes the subject matter of Example 13, and optionally, wherein the grade database comprises data collected from an international sample of athletes from various sports, spanning different age groups ranging from nine to forty years old, including both males and females over a predefined period.

Example 16 includes a product comprising one or more tangible computer-readable non-transitory storage media comprising program instructions for generating a training plan based on the biomechanic qualities of a trainee, wherein execution of the program instructions by one or more processors comprising: activating one or more image sensors to record a video of a predefined movement of a sports trainee in a predetermined plane to provide a video clip; on the video clip, marking two or more keypoints on two or more predetermined points on a body of the sports trainee, extracting coordinates of the two or more keypoints by using a first artificial intelligence (AI) model, and detecting two or more points of interest (POI) from the coordinates; validating the detected two or more POI against the two or more predetermined points and calculating two or more key performance indicators (KPIs) based on the validation; calculating metrics of the KPIs based on one or more rules provided by a metrics rule engine; applying a grading process to the two or more KPIs based on one or more rules provided by a grading rule engine and providing a biomechanical report of the sports trainee; generating a biomechanical model of the sports trainee and a practice plan for the sports trainee having one or more exercises by a second AI model, wherein the one or more exercises are adapted to the biomechanical model of the sports trainee and are designed to reduce the risk of injury of the sports trainee.

Example 17 includes the subject matter of Example 16, wherein the execution of the program instructions of the validation by the one or more processors comprising: capturing the two or more keypoints by synchronously recording a motion of the sports trainee by a two-dimensional (2D) image sensor of the one or more image sensors and comparing the two or more keypoints captured by a three-dimensional (3D) motion capture system and the 2D image sensor to recognize the body position of the sports trainee.

Example 18 includes the subject matter of Example 17, wherein the execution of the program instructions of the comparison the one or more processors comprising: comparing one or more distance-time and velocity-time traces, ankle traces, knee traces, and hip motion traces over time, derived from a vertical motion (z) and a horizontal motion (x) components of selected body keypoints in the 2D space, as captured by the 2D image sensor.

Example 19 includes the subject matter of Example 16 wherein the two or more keypoints on two or more predetermined points on a body of the sports trainee comprise an anatomical landscape of the trainee.

Example 20 includes the subject matter of Example 16, wherein the extraction of the coordinates comprises: extract from the recorded video clip one or more components which represent a time (t), the vertical motion (z), and the horizontal motion (x) of the sports trainee by using computer vision with machine learning methods.

Example 21 includes the subject matter of Example 20, wherein the detection of POI comprises: identifying the POIs on a distance-time and a velocity-time trace derived from the z and x components of two or more keypoints in a 2D space, wherein the POIs are defined as: points exceeding a predefined threshold, points of sign change, and local minima or maxima, which indicate peaks or troughs in motion.

Example 22 includes the subject matter of Example 21, wherein the POIs are used to define the beginning and end of predetermined phases of interest for an analysis of the motion of the sports trainee in the video clip.

Example 23 includes the subject matter of Example 16, wherein the machine learning is configured to train a dataset based on one or more trainee biomechanical data and one or more sports accessories.

Example 24 includes the subject matter of Example 16, wherein one or more sports accessories comprise one or more cones.

Example 25 includes the subject matter of Example 16, wherein the grading process is done by a KPI grader operably coupled to a grading rule engine and comprises: converting absolute values of each KPI into relative values based on the KPI's indicator; providing mean and standard deviation values to an age group and a gender of the trainee, wherein the mean and standard deviation values were primarily calculated using data collected through standardized measurement procedures.

Example 26 includes the subject matter of Example 25, wherein the trainee age for a particular testing session is calculated based on the date of birth of the trainee and the testing date of the trainee, where the age of the trainee is categorized into an age group.

Example 27 includes the subject matter of Example 26 comprises at least one age group comprising children under nine years old (U9), children under eleven years old (U11), children under thirteen years old (U13), children under fifteen years old (U15), children under seventeen years old (U17), children under nineteen years old (U19), and seniors.

Example 28 includes the subject matter of Example 25, wherein the grading further comprises: filtering a grade database by a selected age group and gender to select the mean and standard deviation for the given KPI, wherein values of the selected age group and the gender are subsequently used to convert the absolute KPI into a grade having a percentile value.

Example 29 includes the subject matter of Example 28, wherein the grade database comprises data collected from an international sample of athletes from various sports, spanning different age groups ranging from nine to forty years old, including both males and females over a predefined period.

The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

What is claimed is:

1. A system for generating a training plan based on the biomechanic qualities of a trainee, comprising a user device comprises processing circuitry and one or more sensors, wherein the processing circuitry is configured to:
activate an image sensor to record a video of a predefined movement of a sports trainee in a predetermined plane using a camera of the user device to provide a video clip;
on the video clip, mark two or more keypoints on two or more predetermined points on a body of the sports trainee, extract coordinates of the two or more keypoints by using a first artificial intelligence (AI) model and detect two or more points of interest (POI) from the coordinates;
validate the detected two or more POI against the two or more predetermined points and calculate two or more key performance indicators (KPIs) based on the validation;
calculate metrics of the KPIs based on one or more rules provided by a metrics rule engine;
apply a grading process to the two or more KPIs based on one or more rules provided by a grading rule engine and provide a biomechanical report of the sports trainee;
generate a biomechanical model of the sports trainee and a practice plan for the sports trainee having one or more exercises by a second AI model, wherein the one or more exercises are adapted to the biomechanical model of the sports trainee.

2. The system of claim 1, wherein the one or more exercises are designed to reduce the risk of injury of the sports trainee.

3. The system of claim 1, wherein the validation comprises
capture the two or more keypoints by synchronously recording a motion of the sports trainee by a two-dimensional (2D) video camera of the user device and compare the two or more keypoints captured by a three-dimensional (3D) motion capture system and the 2D video camera to recognize the body position of the sports trainee.

4. The system of claim 3, wherein the comparison comprises at least one of:
one or more distance-time and velocity-time traces, ankle traces, knee traces, and hip motion traces over time, derived from a vertical motion (z) and a horizontal motion (x) components of selected body keypoints in the 2D space, as captured by the 2D video camera.

5. The system of claim 1, wherein the two or more keypoints on two or more predetermined points on a body of the sports trainee comprise an anatomical landscape of the trainee.

6. The system of claim 1, wherein the extraction of the coordinates comprises:
extract from the recorded video clip one or more components which represent a time (t), the vertical motion (z), and the horizontal motion (x) of the sports trainee by using computer vision with machine learning methods.

7. The system of claim 6, wherein the detection of POI comprises:
identify the POIs on a distance-time and a velocity-time trace derived from the z and x components of two or more keypoints in a 2D space, wherein the POIs are defined as: points exceeding a predefined threshold, points of sign change, and local minima or maxima, which indicate peaks or troughs in motion.

8. The system of claim 7, wherein the POIs are used to define the beginning and end of predetermined phases of interest for an analysis of the motion of the sports trainee in the video clip.

9. The system of claim 1, wherein the machine learning is configured to train a dataset based on one or more trainee biomechanical data and one or more sport accessories.

10. The system of claim 1, wherein one or more sports accessories comprise one or more cones.

11. The system of claim 1, wherein the grading process is done by a KPI grader operably coupled to a grading rule engine and comprises:
convert absolute values of each KPI into relative values based on the KPI's indicator
provide mean and standard deviation values to an age group and a gender of the trainee, wherein the mean and standard deviation values were primarily calculated using data collected through standardized measurement procedures.

12. The system of claim 11, wherein an age of the trainee for a particular testing session is calculated based on the date of birth of the trainee and the testing date of the trainee, where the age of the trainee is categorized into an age group.

13. The system of claim 11 comprises at least one age group comprising children under nine years old (U9), children under eleven years old (U11), children under thirteen years old (U13), children under fifteen years old (U15), children under seventeen years old (U17), children under nineteen years old (U19), and seniors.

14. The system of claim 11, wherein the grading further comprises:
filter a grade database by a selected age group and gender to select the mean and standard deviation for the given KPI, wherein values of the selected age group and the gender are subsequently used to convert the absolute KPI into a grade having a percentile value.

15. The system of claim 14, wherein the grade database comprises data collected from an international sample of athletes from various sports, spanning different age groups ranging from nine to forty years old, including both males and females over a predefined period.

16. A product comprising one or more tangible computer-readable non-transitory storage media comprising program instructions for generating a training plan based on the biomechanic qualities of a trainee, wherein execution of the program instructions by one or more processors result in:
activating one or more image sensors to record a video of a predefined movement of a sports trainee in a predetermined plane to provide a video clip;
on the video clip, marking two or more keypoints on two or more predetermined points on a body of the sports trainee, extract coordinates of the two or more keypoints by using a first artificial intelligence (AI) model, and detecting two or more points of interest (POI) from the coordinates, wherein the two or more keypoints on two or more predetermined points on a body of the sports trainee comprise an anatomical landscape of the trainee;
validating the detected two or more POI against the two or more predetermined points and calculating two or more key performance indicators (KPIs) based on the validation;
calculating metrics of the KPIs based on one or more rules provided by a metrics rule engine;
applying a grading process to the two or more KPIs based on one or more rules provided by a grading rule engine and providing a biomechanical report of the sports trainee; and
generating a biomechanical model of the sports trainee and a practice plan for the sports trainee having one or more exercises by a second AI model, wherein the one or more exercises are adapted to the biomechanical model of the sports trainee and are designed to reduce the risk of injury of the sports trainee.

17. The product of claim 16, wherein the execution of the program instructions of the validation by the one or more processors result in:
capturing the two or more keypoints by synchronously recording a motion of the sports trainee by a two-dimensional (2D) image sensor of the one or more image sensors and comparing the two or more keypoints captured by a three-dimensional (3D) motion capture system and the 2D image sensor to recognize the body position of the sports trainee.

18. The product of claim 17, wherein the execution of the program instructions of the comparison when executed result in:
comparing one or more distance-time and velocity-time traces, ankle traces, knee traces, and hip motion traces over time, derived from a vertical motion (z) and a horizontal motion (x) components of selected body keypoints in the 2D space, as captured by the 2D image sensor.

19. The product of claim 16, wherein the execution of the program instructions of the grading process is done by a KPI grader operably coupled to a grading rule engine and the instruction when executed result in:
converting absolute values of each KPI into relative values based on the KPI's indicator
providing mean and standard deviation values to an age group and a gender of the trainee, wherein the mean and standard deviation values were primarily calculated using data collected through standardized measurement procedures, wherein the trainee age for a particular testing session is calculated based on the date of birth of the trainee and the testing date of the trainee, where the age of the trainee is categorized into an age group.

20. The product of claim 13, wherein the grading process further comprises:
filtering a grade database by a selected age group and gender to select the mean and standard deviation for the given KPI, wherein values of the selected age group and the gender are subsequently used to convert the absolute KPI into a grade having a percentile value, wherein the grade database comprises data collected from an international sample of athletes from various sports, spanning different age groups ranging from nine to forty years old, including both males and females over a predefined period.
